(19) United States
(12) Patent Application Publication
(10) Pub. No.: US 2018/0299066 A1
(43) Pub. Date: Oct. 18, 2018

(54) APPARATUS FOR ISOTROPIC SHELL STRUCTURE UNIT CELLS FOR STRUCTURAL LIGHTWEIGHTING

(71) Applicant: General Electric Company, Schenectady, NY (US)

(72) Inventors: Daniel Jason Erno, Clifton Park, NY (US); Michael Colan Moscinski, Glenville, NY (US); William Dwight Gerstler, Niskayuna, NY (US); Thomas Vincent Tancogne-Dejean, Cambridge, MA (US)

(21) Appl. No.: 15/945,057

(22) Filed: Apr. 4, 2018

Related U.S. Application Data
(60) Provisional application No. 62/486,323, filed on Apr. 17, 2017.

(51) Int. Cl. F16S 5/00

(52) U.S. Cl. CPC F16S 5/00; B33Y 80/00

(57) ABSTRACT

A shell unit cell structure includes at least one junction and a plurality of connectors. The plurality of connectors are coupled to the at least one junction. The at least one junction and the plurality of connectors form an integral surface. The shell unit cell structure has an isotropic stiffness.

### CROSS-REFERENCE TO RELATED APPLICATIONS

This application claims the benefit of U.S. Provisional Application No. 62/486,323 filed on Apr. 17, 2017, the contents of which are incorporated herein by reference in their entirety.

### BACKGROUND

The field of the disclosure relates generally to an apparatus for unit cell structures for internal lightweighting and, more particularly, to an apparatus for an isotropic shell structure unit cell.

At least some components are manufactured for internal lightweighting using additive manufacturing. Internal lightweighting uses periodic internal unit cell structures to replace the internal structure of solid components. Each internal unit cell structure includes a node and at least one beam coupled to the node. Each beam is coupled to the node of another internal unit cell structure to form a repeating periodic lattice structure within a component. The internal unit cell structures reduce the weight of otherwise solid components while maintaining the ability of the component to carry a load. At least some such internal unit cell structures, however, are orthotropic, or stiffer, in a first direction than in a second direction.

At least some internal unit cell structures include hollow nodes and beams (or shell structures) to further reduce the mass and weight of the lattice structure while maintaining the ability of the component to carry a load. Such internal shell unit cell structures are also orthotropic, or stiffer, in a first direction than in a second direction. If the component containing the shell unit cell lattice structure is loaded asymmetrically, the stiffness of the component is different in the first direction from the stiffness of the component in the second direction. Thus, the lightwieghted component containing the shell unit cell lattice structure will not have the same reaction to asymmetrical loading as a solid component without the lattice structure.

### BRIEF DESCRIPTION

In one aspect, a shell unit cell structure is provided. The shell unit cell structure includes at least one junction and a plurality of connectors. The plurality of connectors are coupled to the at least one junction. The at least one junction and the plurality of connectors form an integral surface. The shell unit cell structure has an isotropic stiffness.

In yet another aspect, a component is provided. The component includes a lattice structure which includes a plurality of shell unit cell structures. Each shell unit cell structure of the plurality of shell unit cell structures includes at least one junction and a plurality of connectors. The plurality of connectors are coupled to the at least one junction. The at least one junction and the plurality of connectors form an integral surface. The shell unit cell structure has an isotropic stiffness.

### DRAWINGS

These and other features, aspects, and advantages of the present disclosure will become better understood when the following detailed description is read with reference to the accompanying drawings in which like characters represent like parts throughout the drawings, wherein:

FIG. 1 is a partial cut away perspective view of a component with an exemplary lattice structure;

FIG. 2 is a perspective view of an exemplary unit cell of the lattice structure shown in FIG. 1;

FIG. 3 is a perspective view of an exemplary junction of the unit cell shown in FIG. 2;

FIG. 4 is a side view of an exemplary unit cell shown in FIG. 2;

FIG. 5 is a perspective view of another exemplary unit cell of the lattice structure shown in FIG. 1;

FIG. 6 is a perspective view of an alternative exemplary single shell unit cell structure for use with the lattice structure shown in FIG. 1;

FIG. 7 is a front view of the shell unit cell structure shown in FIG. 6; and

FIG. 8 is a section view of the shell unit cell structure taken about section line 8-8 of FIG. 7.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Embodiments of the isotropic shell structure unit cell described herein facilitate manufacturing a component using an additive manufacturing process where the component includes an internal lattice structure with an isotropic stiffness. The lattice structure includes a plurality of unit cell structures arranged in a lattice configuration within the component. Each unit cell structure includes at least one junction and a plurality of connectors coupled to the junction. Each connector is coupled to a connector of another unit cell structure to form a repeating periodic lattice structure within a component. The junctions and connectors forming the unit cell structure are hollow, thereby forming shell unit cells. The junctions and the connectors form an integral surface which forms the lattice structure. The lattice structure, formed from a plurality of shell unit cell structures, replaces a solid material or structure within a component. The lattice structure reduces the weight of the component while maintaining the ability of the component to carry a load. The shell unit cell lattice structure further reduces the weight of the component by reducing the mass and weight of the individual unit cells.

Each junction of the shell unit cell includes a plurality of connection points coupled to the connectors. Each junction further includes a wall thickness and a junction length. In addition, each connector and connection location of the shell unit cell includes a diameter. Moreover, each connector includes a connector length and a wall thickness. The junction and connector wall thickness, the junction length, the connector diameter, and the connector length are configured such that a stiffness of the shell unit cell, and therefore a component with the internal lattice structure is isotropic. That is, the stiffness of the component is substantially same value when measured in different directions. Isotropic stiffness of the component allows the component to react to asymmetric loads in the same way a solid component reacts to asymmetric loads. This facilitates designing the component without concern for asymmetric strength of the material used to form the component.

Additive manufacturing processes and systems include, for example, and without limitation, vat photopolymerization, powder bed fusion, binder jetting, material jetting, sheet lamination, material extrusion, directed energy deposition and hybrid systems. These processes and systems include, for example, and without limitation, SLA—Stereolithography Apparatus, DLP—Digital Light Processing, 3SP—Scan, Spin, and Selectively Photocure, CLIP—Continuous Liquid Interface Production, SLS—Selective Laser Sintering, DMLS—Direct Metal Laser Sintering, SLM—Selective Laser Melting, EBM—Electron Beam Melting, SHS—Selective Heat Sintering, MJF—Multi-Jet Fusion, 3D Printing, Voxeljet, Polyjet, SCP—Smooth Curvatures Printing, MJM—Multi-Jet Modeling Projet, LOM—Laminated Object Manufacture, SDL—Selective Deposition Lamination, UAM—Ultrasonic Additive Manufacturing, FFF—Fused Filament Fabrication, FDM—Fused Deposition Modeling, LMD—Laser Metal Deposition, LENS—Laser Engineered Net Shaping, DMD—Direct Metal Deposition, Hybrid Systems, and combinations of these processes and systems. These processes and systems may employ, for example, and without limitation, all forms of electromagnetic radiation, heating, sintering, melting, curing, binding, consolidating, pressing, embedding, and combinations thereof.

Additive manufacturing processes and systems employ materials including, for example, and without limitation, polymers, plastics, metals, ceramics, sand, glass, waxes, fibers, biological matter, composites, and hybrids of these materials. These materials may be used in these processes and systems in a variety of forms as appropriate for a given material and the process or system, including, for example, and without limitation, as liquids, solids, powders, sheets, foils, tapes, filaments, pellets, liquids, slurries, wires, atomized, pastes, and combinations of these forms.

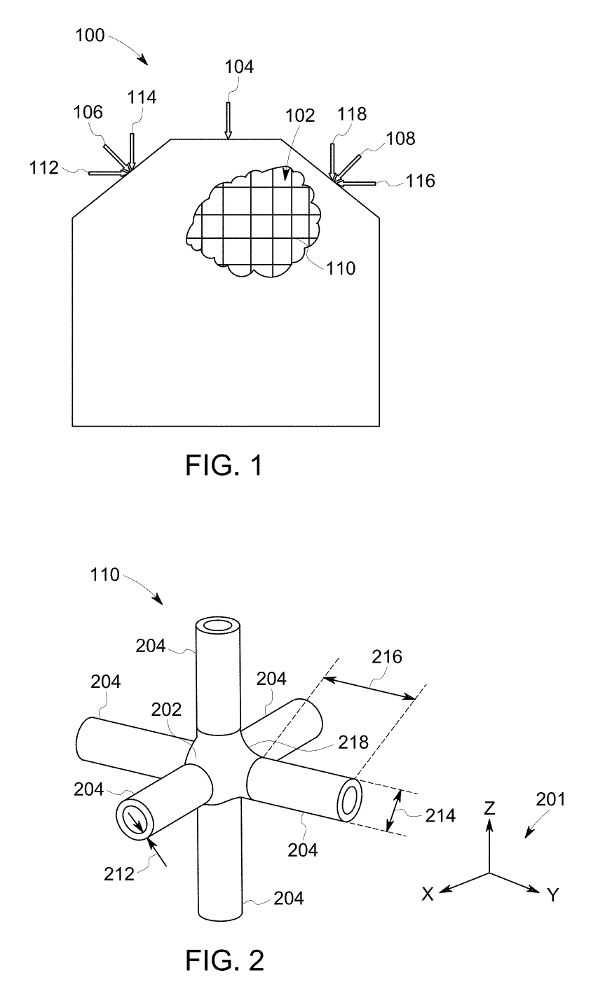

FIG. 1 is a partial cut away view of a component 100 with an exemplary embodiment of a lattice structure 102. In the exemplary embodiment, lattice structure 102 replaces a solid material or structure within component 100 and facilitates reducing a weight of component 100 while maintaining the ability of component 100 to carry a load, such as loads 104, 106, and 108. Lattice structure 102 includes a plurality of shell unit cell structures 110 arranged in a lattice configuration within component 100.

Shell unit cell structures 110 are configured such that a stiffness of component 100 is isotropic. That is, the stiffness of component 100 is substantially similar in all directions. As illustrated in FIG. 1, three loads 104, 106, and 108 are applied to component 100. Load 104 applies a vertical load to component 100. Load 106 applies an angular load to component 100, and includes a horizontal component 112 and a vertical component 114. Side load 108 applies an angular load to component 100, and includes a horizontal component 116 and a vertical component 118. In the exemplary embodiment, lattice structure 102 and shell unit cell structures 110 are configured such that the stiffness of component 100 is substantially similar whether vertical load components 104, 114, and 118 are applied to component 100 or whether horizontal load components 112 and 116 are applied to component 100. In addition, lattice structure 102 and shell unit cell structures 110 are configured such that the stiffness of component 100 is substantially similar when component 100 is asymmetrically loaded. That is, the stiffness of component 100 is substantially similar when only left side load 106, right side load 108, or vertical load 104 is applied to component 100. Thus, isotropic stiffness of component 100 allows component 100 to react to asymmetric loads in substantially similar way a solid component reacts to asymmetric loads.

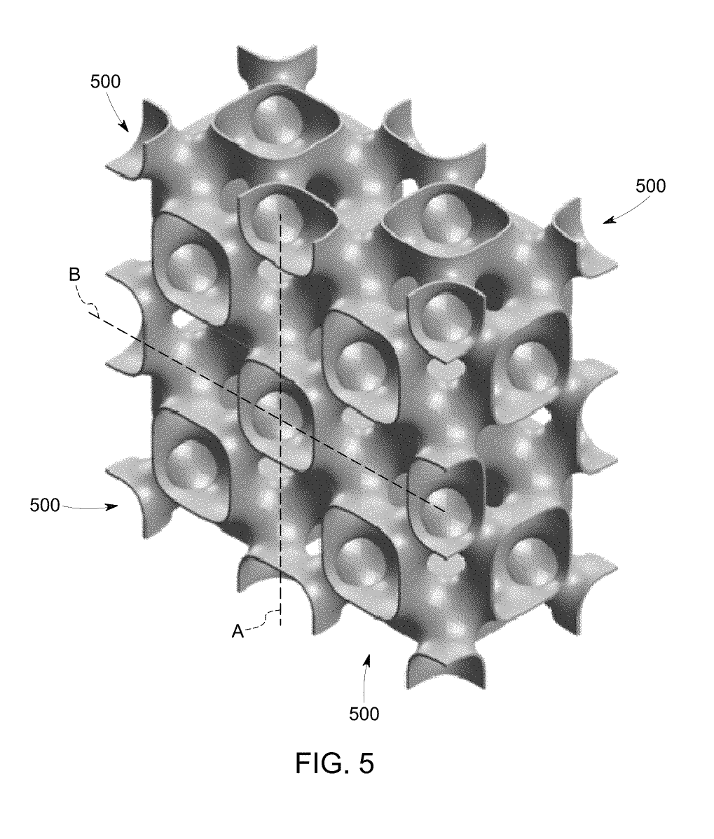

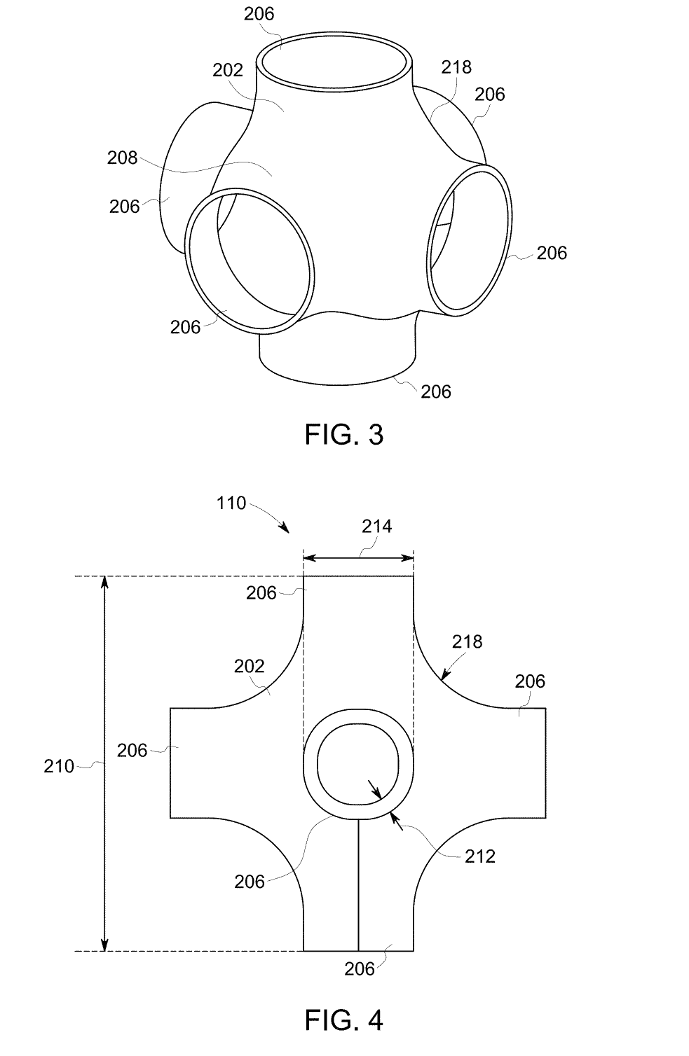

FIG. 2 is a perspective view of an exemplary embodiment of one configuration of a shell unit cell structure, such as shell unit cell structure 110. FIG. 3 is a perspective view of an exemplary embodiment of a junction 202 of shell unit cell structure 110. FIG. 4 is a side view of junction 202. In the exemplary embodiment, shell unit cell structure 110 includes at least one junction 202 and a plurality of connectors 204. In particular, the example embodiment of shell unit cell structure 110 includes one junction 202 and six connectors 204 coupled to junction 202. In the exemplary embodiment, shell unit cell structure 110 is unit cell of a family that may be referred to as an axes-of-coordinates-style unit cell. That is, each of connectors 204 extend away from a central junction 202 along a line parallel to one of the three axes (X, Y, and Z) illustrated by coordinate system 201. Coordinate system 201 includes an ordered triplet of axes that are pair-wise perpendicular. It is noted that shell unit cell structure 110 includes any number of junctions 202 and connectors 204 that enable shell unit cell structure 110 to function as described herein.

In the exemplary embodiment, junctions 202 and connectors 204 are shown as discrete, separate parts of shell unit cell structure 110 for convenience only. Specifically, shell unit cell structure 110 is a monolithic component manufactured using an additive manufacturing system, not a combination of separate junctions 202 and connectors 204. As such, junctions 202 and connectors 204 describe portions of a monolithic shell unit cell structure 110, and are not discrete, separate parts of shell unit cell structure 110. Additionally, lattice structure 102 within component 100 is also a monolithic component manufactured using an additive manufacturing system. That is, each shell unit cell structure 110 within lattice structure 102 describes a portion of lattice structure 102, and not a discrete, separate part of lattice structure 102. The plurality of shell unit cell structures 110 within lattice structure 102 are formed such that an integral or complex, continuous surface forms lattice structure 102. Junctions 202, connectors 204, and shell unit cell structure 110 describe portions of an overall monolithic lattice structure 102, and are not discrete, separate parts of lattice structure 102.

In the exemplary embodiment, connectors 204 are substantially similar and have a cylindrical tubular shape, i.e., they form a hollow cylindrical shape. Alternatively, connectors 204 include any shape that enables shell unit cell structure 110 to function as described herein. In the exemplary embodiment, connectors 204 include a wall thickness 212, a diameter 214, and a connector length 216. Junction 202 includes a junction length 210 and a plurality of connection locations 206 configured to couple connectors 204 to junction 202. Additionally, junction 202 is hollow and includes an outer shell wall 208 having wall thickness 212. In alternative embodiments, outer shell wall 208 has a thickness different than wall thickness 212 of connectors 204. In the exemplary embodiment, outer shell wall 208 includes a curved surface that blends each connection location 206 to an adjacent connection location 206 with a full radius 218, as best shown in FIG. 4. Connection locations 206 extend from outer shell wall 208 and include a sectional shape that is complementary to or corresponds to a sectional shape of connectors 204. In the exemplary embodiment, junction 202 includes six connection locations 206. Alternatively, in other embodiments, junction 202 includes any number of connection locations 206 that enables shell unit cell structure 110 to function as described herein. In the exemplary embodiment, connection locations 206 include a circular shape with diameter 214 to complement or correspond to the cylindrical tubular shape of connectors 204. Alternatively, connection locations 206 include any shape and size that enables shell unit cell structure 110 to function as described herein.

In the exemplary embodiment, junction length 210, thickness 212, diameter 214, and connector length 216 are configured to form an isotropic shell unit cell structure 110, such that a stiffness of component 100 is substantially similar in all directions. The isotropic stiffness of component 100 allows component 100 to react to asymmetric loads in substantially the same way a solid component reacts to asymmetric loads. While the dimensional relationship between junction length 210, thickness 212, diameter 214, and connector length 216 are substantially similar for a particular family of shell unit cells, such as the axes-of-coordinates-style shell unit cell structure 110 shown in FIG. 2, the relationship may not be the same across different families of isotropic unit cells. In particular, a mathematical expression exists including, for example, junction length 210, thickness 212, diameter 214, and connector length 216 variables such that the resulting family of shell unit cells, such as shell unit cell structure 110, are isotropic. The mathematical expression, however, may not be identical across all families of isotropic shell unit cells. A unit cell family, as used herein, includes unit cells with the same number of junctions and same number of connectors.

In the exemplary embodiment, one example of an isotropic axes-of-coordinates-style unit cell is shell unit cell structure 110 shown in FIG. 2. Shell unit cell structure 110 includes wall thickness 212 values in a range between and including about 0.05 millimeters (mm) (0.002 inches (in.)) and about 0.5 mm (0.020 in.), and more particularly, in a range between and including about 0.1 mm (0.004 in.) and about 0.15 mm (0.006 in.), and preferably range between and including about 0.12 mm (0.005 in.) and about 0.14 mm (0.006 in.). In one particular embodiment, wall thickness 212 is about 0.13 mm (0.005). Alternatively, wall thickness 212 includes any value that enables shell unit cell structure 110 to function as described herein.

Furthermore, in the exemplary embodiment, junction length 210 includes values in a range between and including about 5.0 mm (0.197 in.) and about 1.0 mm (0.039 in.), and more particularly, in a range between and including about 4.5 mm (0.177 in.) and about 2.0 mm (0.079 in.), and preferably in a range between and including about 4.0 mm (0.157 in.) and about 3.0 mm (0.118 in.). In one particular embodiment, junction length 210 is about 3.5 mm (0.138 in.). Alternatively, junction length 210 includes any length that enables shell unit cell structure 110 to function as described herein.

Moreover, in the exemplary embodiment, diameter 214 includes values in a range between and including about 2.0 mm (0.079 in.) and about 0.1 mm (0.004 in.), and more particularly, in a range between and including about 1.5 mm (0.059 in.) and about 0.4 mm (0.016 in.), and preferably in a range between and including about 1.25 mm (0.049 in.) and about 0.7 mm (0.028 in.). In one particular embodiment, diameter 214 is about 0.9 mm (0.035 in.). Alternatively, diameter 214 includes any value that enables shell unit cell structure 110 to function as described herein.

FIG. 5 is a perspective view of an exemplary embodiment of a plurality of shell unit cell structures 500 coupled together to form a portion of a lattice structure, such as lattice structure 102 (shown in FIG. 1). In the exemplary embodiment, four shell unit cell structures 500 are shown coupled together with the individual cell boundaries denoted by dashed lines “A” and “B.” As described above, the lattice structure replaces a solid material or structure within a component, such as component 100 (shown in FIG. 1), and facilitates reducing a weight of the component. In addition, shell unit cell structures 500 have an isotropic stiffness, which facilitates the component reacting to asymmetric loads in a substantially similar way as a solid component reacts to asymmetric loads.

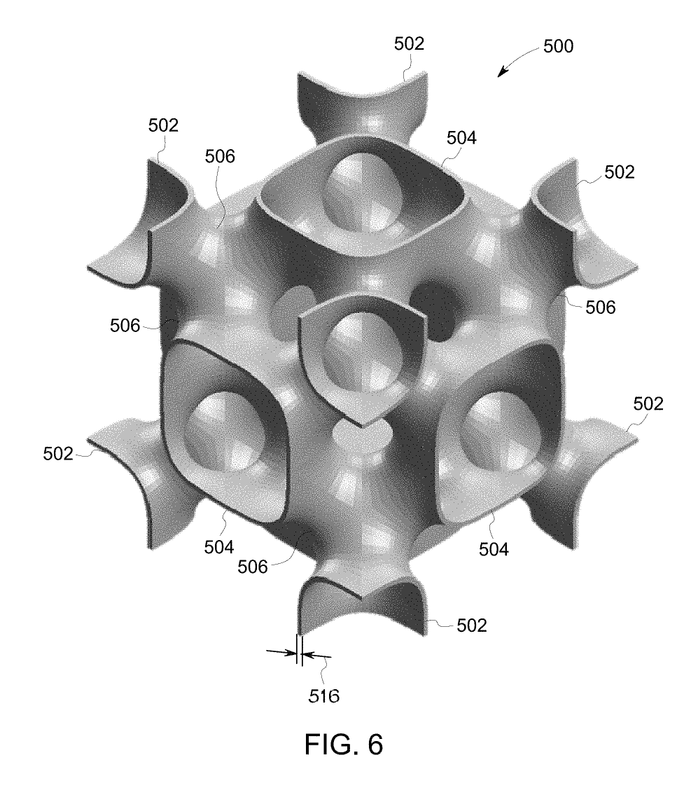

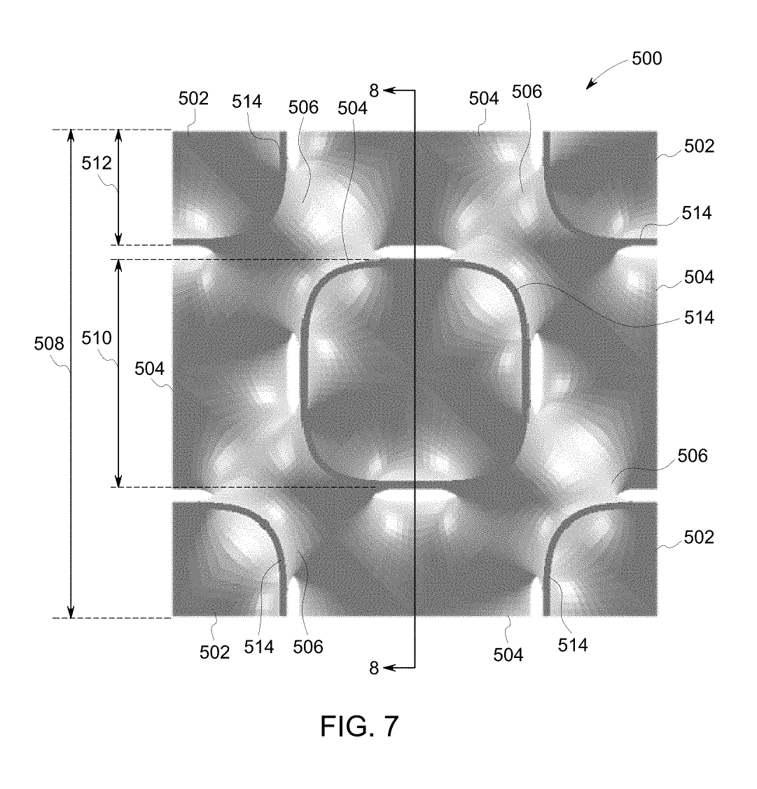

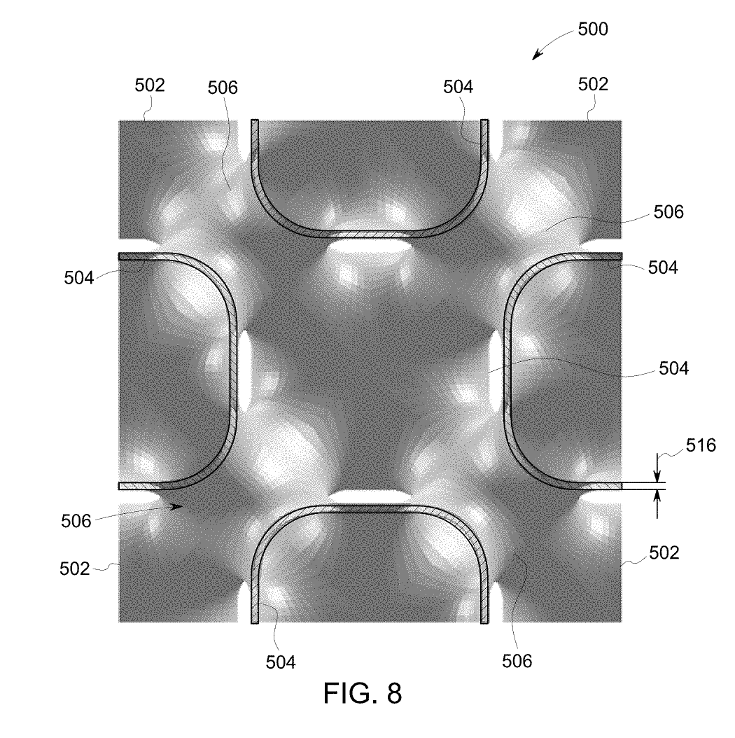

FIG. 6 is a perspective view of a single shell unit cell structure 500. FIG. 7 is a front view of shell unit cell structure 500. FIG. 8 is a section view of shell unit cell structure 500 taken about section line 8-8 of FIG. 7. In the exemplary embodiment, shell unit cell structure 500 is generally cubic shaped and may be referred to as a face-centered-style unit cell. The exemplary shell unit cell structure 500 includes a plurality of hollow corner junctions 502 and hollow face junctions 504. In particular, shell unit cell structure 500 includes a corner junction 502 at each corner of the cubic shaped cell. Each corner junction 502 at a corner is shared between adjacent shell unit cell structures 500 (as shown in FIG. 5), such that within a lattice structure, such as lattice structure 102, a fully formed junction (not shown) is formed from eight shell unit cell structures 500. As such, each corner junction 502 contains ⅛ of a fully formed junction. In addition, shell unit cell structure 500 includes a face junction 504 at the center of each face of the cubic shaped cell. Each face junction 504 at a face center is shared between adjacent shell unit cell structures 500, such that within a lattice structure, such as lattice structure 102, a fully formed junction (not shown) is formed from two shell unit cell structures 500. As such, each face junction 504 contains ½ of a fully formed junction.

Furthermore, in the exemplary embodiment, shell unit cell structure 500 includes a plurality of connectors 506. In particular, each connector 506 extends between a corner junction 502 and an adjacent face junction 504. As such, each respective corner junction 502 includes three connectors 506 extending away from corner junction 502, where each respective connector 506 extends to a respective adjacent face junction 504. In the exemplary embodiment, connectors 506 have a hyperboloid of one sheet shape and are hollow. That is, connectors 506 are hollow hyperboloid-shaped tubes extending between junctions 502 and 504, generating a curved transition between junctions 502 and 504. Alternatively, connectors 506 can have any shape that enables shell unit cell structure 500 to function as described herein. As shown in FIG. 6, each of the three connectors 506 extending away from a corner junction 502 intersect to form a passage between the respective corner junction 502 and the three adjacent face junctions 504.

In the exemplary embodiment, shell unit cell structure 500 has a length 508. In addition, each face junction 504 has a length 510, and as such, each corner junction 502 has a length 512 that is 1/2 length 510. Face curves 514 of the four corners of each face junction 504 and the corner junctions 502 on each face of shell unit cell structure 500 are hyperbolas defined in part by the hyperboloid-shaped connectors 508. While corner junction 502, face junction 504, and connectors 506 are described herein as being hollow, it is noted that each of corner junction 502, face junction 504, and connectors 506 are formed as thin-walled members having a substantially similar wall thickness 516. In the exemplary embodiment, lengths 508, 510, and 512, curves 514, and thickness 516 are configured to form an isotropic shell unit cell structure 500, such that a stiffness of shell unit cell structure 500 is substantially similar in all directions. As described above, a mathematical expression exists including, for example, lengths 508, 510, and 512, curves 514, and thickness 516 variables such that the resulting family of shell unit cells, such as shell unit cell structure 500, are isotropic. Isotropic stiffness of shell unit cell structure 500 facilitates fabricating a component, such as component 100, from a lattice of shell unit cell structure 500 that allows the component to react to asymmetric loads in the same way a solid component reacts to asymmetric loads.

The above-described shell unit cell structures provide an efficient method for lightweighting a component. Specifically, the wall thickness, the junction and connector lengths, and the connector diameter are configured such that a stiffness of the component with the internal lattice structure is isotropic. That is, the stiffness of the component is substantially similar in all directions. Isotropic stiffness of the component allows the component to react to asymmetric loads in the same way a solid component reacts to asymmetric loads.

An exemplary technical effect of the methods, systems, and apparatus described herein includes at least one of: (a) replacing the solid structure of a component with a shell unit cell lattice structure; (b) reducing the weight of a component; and (c) creating a component with an internal shell unit cell lattice structure having an isotropic stiffness.

Exemplary embodiments of isotropic shell unit cell structures are described above in detail. The isotropic shell unit cell structures, and methods of operating such units and devices are not limited to the specific embodiments described herein, but rather, components of systems and/or steps of the methods may be utilized independently and separately from other components and/or steps described herein. For example, the methods may also be used in combination with other components which require a lattice internal structure, and are not limited to practice with only the systems and methods as described herein. Rather, the exemplary embodiment may be implemented and utilized in connection with many other manufacturing or construction applications that require a lattice structure.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A shell unit cell structure comprising:
at least one junction; and
a plurality of connectors coupled to said at least one junction, wherein said at least one junction and said plurality of connectors form an integral surface, and said shell unit cell structure having an isotropic stiffness.

2. The shell unit cell structure of claim 1, wherein each connector of said plurality of connectors is hollow.

3. The shell unit cell structure of claim 1, wherein said at least one junction is hollow.

4. The shell unit cell structure of claim 1, wherein said at least one junction and said plurality of connectors are hollow.

5. The shell unit cell structure of claim 4, wherein said at least one junction and said plurality of connectors have a wall thickness that is substantially equal.

6. The shell unit cell structure of claim 4, wherein said junction comprises a plurality of connection locations, said plurality of connectors coupled to said plurality of connection locations.

7. The shell unit cell structure of claim 1, wherein said shell unit cell structure is an axes-of-coordinates-style unit cell structure, said at least one junction centered between said plurality of connectors.

8. The shell unit cell structure of claim 1, wherein said shell unit cell structure is a cubic shaped face-centered-style unit cell.

9. The shell unit cell structure of claim 8, wherein said at least one junction comprises a plurality of corner junctions and a plurality of face junctions.

10. The shell unit cell structure of claim 9, wherein each respective corner junction of said plurality of corner junctions is coupled to at least one adjacent face junction of said plurality of face junctions by at least one connector of said plurality of connectors.

11. The shell unit cell structure of claim 1, wherein said plurality of connectors are hyperboloid-shaped tubes.

12. A component comprising:
a lattice structure comprising a plurality of shell unit cell structures, each shell unit cell structure of said plurality of shell unit cell structures comprising:
at least one junction; and
a plurality of connectors coupled to said at least one junction, wherein said at least one junction and said plurality of connectors form an integral surface, and said shell unit cell structure having an isotropic stiffness.

13. The component of claim 12, wherein said at least one junction and said plurality of connectors are hollow.

14. The component of claim 13, wherein said at least one junction and said plurality of connectors have a wall thickness that is substantially equal.

15. The component of claim 13, wherein said junction comprises a plurality of connection locations, said plurality of connectors coupled to said plurality of connection locations.

16. The component of claim 12, wherein said each shell unit cell structure is an axes-of-coordinates-style unit cell structure, said at least one junction centered between said plurality of connectors.

17. The component of claim 12, wherein said each shell unit cell structure is a cubic shaped face-centered-style unit cell.

18. The component of claim 17, wherein said at least one junction comprises a plurality of corner junctions and a plurality of face junctions.

19. The component of claim 18, wherein each respective corner junction of said plurality of corner junctions is coupled to at least one adjacent face junction of said plurality of face junctions by at least one connector of said plurality of connectors.

20. The component of claim 12, wherein said plurality of connectors are hyperboloid-shaped tubes.
